(19) United States
(12) Patent Application Publication
(10) Pub. No.: US 2011/0228349 A1
(43) Pub. Date: Sep. 22, 2011

(54) IMAGE READING APPARATUS

(75) Inventors: Akira IWAYAMA, Ishikawa (JP); Yuki KASAHARA, Ishikawa (JP); Masahiko KOBAKO, Ishikawa (JP)

(73) Assignee: PFU LIMITED, Ishikawa (JP)

(21) Appl. No.: 12/833,223

(22) Filed: Jul. 9, 2010

(30) Foreign Application Priority Data
Mar. 16, 2010 (JP) 2010-059527

(51) Int. Cl. H04N 1/04

(52) U.S. Cl. 358/474

(57) ABSTRACT

An apparatus includes imaging units, each including: a light source to emit light; and an image sensor to pick up an image of a medium to be moved relatively between the imaging units. The light source of one of the imaging units is provided at a position where a direct light is guided to the image sensor of the other imaging unit, and the image sensor of the other imaging unit is configured to pick up an image for image formation when a reflected light emitted from the light source of the other imaging unit and reflected by the medium is guided to the image sensor of the other imaging unit, and to pick up an image for edge detection when the direct light is guided to the image sensor of the other imaging unit, and an edge of the medium is detected based on the image for edge detection.

### CROSS-REFERENCE TO RELATED APPLICATIONS

This application is based upon and claims the benefit of priority from Japanese Patent Application No. 2010-059527, filed Mar. 16, 2010, the entire contents of which are incorporated herein by reference.

### BACKGROUND OF THE INVENTION

1. Field of the Invention

The present invention relates to an image reading apparatus and, more specifically, to an image reading apparatus capable of detecting an edge of a read medium.

2. Description of the Related Art

There are some image reading apparatuses capable of reading images formed on both sides of a sheet-type read medium in one job or capable of performing duplex reading. As the image reading apparatus, for example, Japanese Laid-open Patent Publication No. 2007-166213 discloses a device in which imaging units each including a light source and an image sensor are oppositely arranged across the read medium.

Incidentally, in the image reading apparatus, if the read medium is smaller in size than a readable area, an image other than the read medium may be included in a read image. In order to extract (crop) only the image of the read medium from the read image, the image reading apparatus has to detect edges of the image of the read medium. Hereinafter, detecting the edges of the image of the read medium is sometimes called “edge detection”. The image reading apparatuses are required to achieve edge detection with higher accuracy. The image reading apparatus provided with a pair of imaging units oppositely arranged as disclosed in Japanese Laid-open Patent Publication No. 2007-166213 is also required to achieve edge detection with higher accuracy.

### SUMMARY OF THE INVENTION

It is an object of the present invention to at least partially solve the problems in the conventional technology.

According to an aspect of the present invention, an image reading apparatus includes a pair of imaging units. Each imaging unit includes: a light source configured to emit light; and an image sensor configured to pick up an image of a medium to be moved relatively between the pair of imaging units. The light source of at least one of the imaging units is provided at a position where a direct light is guided to the image sensor of the other imaging unit, and the image sensor of the other imaging unit is configured to pick up an image for image formation when a reflected light emitted from the light source of the other imaging unit and reflected by the medium is guided to the image sensor of the other imaging unit, and to pick up an image for edge detection when the direct light is guided to the image sensor of the other imaging unit, and an edge of the medium is detected based on the image for edge detection.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an explanatory diagram schematically representing an image reading apparatus according to a first embodiment;

FIG. 2 is a functional block diagram of a control unit;

FIG. 3 is a flowchart of a control procedure according to the first embodiment;

FIG. 4 is an explanatory diagram schematically representing RGB read image data according to the first embodiment;

FIG. 5 is an explanatory diagram schematically representing an RGB read image according to the first embodiment formed with reflected-light line images;

FIG. 6 is an explanatory diagram representing magnitudes of signals output by image sensors depending on whether an original is present or not present;

FIG. 7 is an explanatory diagram schematically representing edge detection according to the first embodiment performed by an edge detector;

FIG. 8 is an explanatory diagram schematically representing an image reading apparatus according to a first modified example;

FIG. 9 is an explanatory diagram schematically representing an image reading apparatus according to a second embodiment;

FIG. 10 is a flowchart of a control procedure according to the second embodiment;

FIG. 11 is an explanatory diagram schematically representing RGB read image data according to the second embodiment;

FIG. 12 is an explanatory diagram schematically representing the RGB read image data according to the second embodiment formed with reflected-light line images;

FIG. 13 is an explanatory diagram representing how to interpolate a missing line image;

FIG. 14 is an explanatory diagram schematically representing edge detection according to the second embodiment performed by the edge detector;

FIG. 15 is a flowchart of a control procedure according to a third embodiment;

FIG. 16 is an explanatory diagram schematically representing RGB read image data according to the third embodiment;

FIG. 17 is a flowchart of a control procedure according to a third embodiment;

FIG. 18 is an explanatory diagram schematically representing RGB read image data according to the second modified example;

FIG. 19 is an explanatory diagram for explaining a method of forming an RGB read image with reduced “show-through”; and

FIG. 20 is an explanatory diagram schematically representing an image reading apparatus according to a third modified example.

### DETAILED DESCRIPTION OF THE PREFERRED EMBODIMENTS

The present invention will be explained in detail below with reference to the accompanying drawings. It should be noted that the present invention is not limited by embodiments as follows. Components in the embodiments include those that can be easily thought of by persons skilled in the art or those substantially equivalent. Moreover, the embodiments will explain an image scanner as an image reading apparatus, however, the present invention is not limited thereto, and thus, any one of a copier, a facsimile, and a character recognition system may be used if a read medium is read by an image sensor. Furthermore, the embodiments will explain an automatic document feeder scanner as the image scanner that causes an image sensor and a read medium to relatively move by moving the read medium to the image sensor. However, the present invention is not limited thereto, and thus, there may be used a flathead scanner that causes an image sensor and a read medium to relatively move by moving the image sensor to the read medium.

### First Embodiment

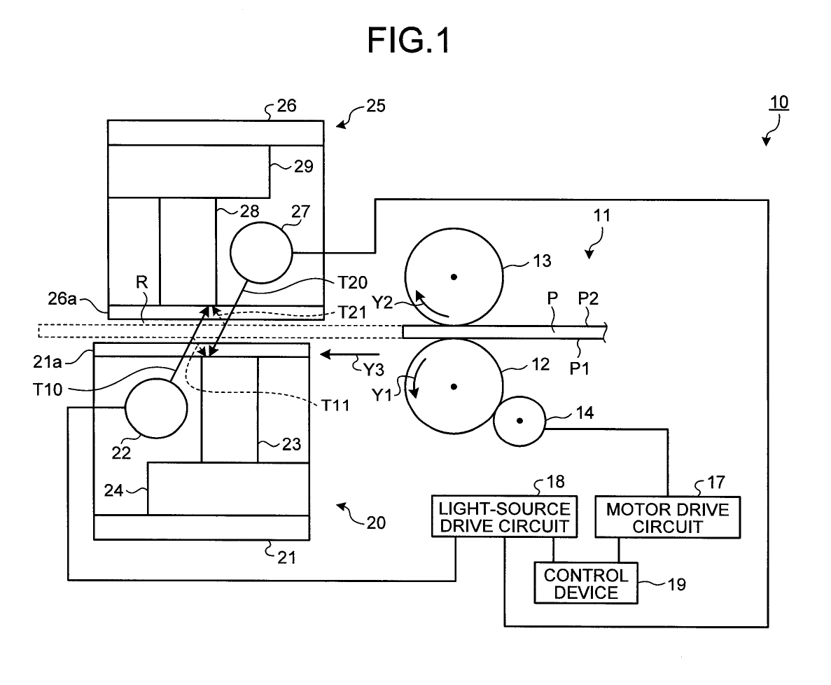

FIG. 1 is an explanatory diagram schematically representing an image reading apparatus according to a first embodiment. In the following embodiments, a read medium is called “original P”, and surfaces to be read are called “printed front surface P1” and “printed rear surface P2”. The printed front surface P1 is a first side (front side) of the original P and the printed rear surface P2 is a second side (rear side) of the original P. An image reading apparatus 10 according to the first embodiment includes, as depicted in FIG. 1, a conveying device 11, a first imaging unit 20, a second imaging unit 25, a motor drive circuit 17, a light-source drive circuit 18, and a control unit 19. The conveying device 11 relatively moves the first imaging unit 20/the second imaging unit 25 and the original P. In the first embodiment, the conveying device 11 conveys the original P to the first imaging unit 20 and the second imaging unit 25.

The conveying device 11 includes a conveying roller 12, a conveying roller 13, and a conveying-roller motor 14. The conveying roller 12 and the conveying roller 13 are supported so as to be mutually oppositely rotatable. The conveying-roller motor 14 provides torque to the conveying roller 12 and causes the conveying roller 12 to rotate. Rotation of the conveying-roller motor 14 causes the conveying roller 12 to rotate in a direction of arrow Y1. When the original P is guided to between the conveying roller 12 and the conveying roller 13, the original P moves in a direction of arrow Y3 through a rotation of the conveying roller 12. The direction of arrow Y3 is a direction in which the original P approaches the first imaging unit 20 and the second imaging unit 25. At this time, the conveying roller 13 rotates in a direction of arrow Y2 being an opposite direction to the direction of arrow Y1. In this manner, the conveying device 11 guides the original P to the first imaging unit 20 and the second imaging unit 25.

The first imaging unit 20 and the second imaging unit 25 are provided in a mutually opposite manner. The conveying device 11 guides the original P to between the first imaging unit 20 and the second imaging unit 25. The first imaging unit 20 reads the printed front surface P1 of the original P conveyed by the conveying device 11. The second imaging unit 25 reads the printed rear surface P2 of the original P conveyed by the conveying device 11. More specifically, the first imaging unit 20 and the second imaging unit 25 read the original P in a main scanning direction. It should be noted that the main scanning direction is a direction parallel to the printed front surface P1 and the printed rear surface P2 of the original P and is orthogonal to a conveying direction of the original P. In addition, the main scanning direction is also a direction orthogonal to the plane of paper in FIG. 1. The first imaging unit 20 and the second imaging unit 25 are fixed to a housing (not shown) of the image reading apparatus 10.

The first imaging unit 20 and the second imaging unit 25 are, for example, a contact optical system. The contact optical system separately emits R light, G light, and B light from a light source unit, and guides lights of the R light, G light, and B light from the original P to the image sensor. The first imaging unit 20 and the second imaging unit 25 may be a reduction optical system. The reduction optical system emits white light from a light source and repeats reflection and convergence of a light flux using a plurality of mirrors and lenses, and then guides the light from an original to an image sensor using the optical system. The first embodiment will explain the case in which the first imaging unit 20 and the second imaging unit 25 are the contact optical system.

The first imaging unit 20 includes a first unit housing 21, a first transmission plate 21a, a first light-source unit 22, a first lens 23, and a first image sensor 24. The second imaging unit 25 includes a second unit housing 26, a second transmission plate 26a, a second light-source unit 27, a second lens 28, and a second image sensor 29. The first unit housing 21 supports the other configuration elements (components) of the first imaging unit 20. The second unit housing 26 supports the other configuration elements (components) of the second imaging unit 25.

The first transmission plate 21a and the second transmission plate 26a are plate members for transmitting light. The first transmission plate 21a and the second transmission plate 26a are, for example, glass plates. The first transmission plate 21a is provided in the first unit housing 21. The second transmission plate 26a is provided in the second unit housing 26. The first transmission plate 21a and the second transmission plate 26a are spaced and provided in mutually parallel to each other. With this feature, in the image reading apparatus 10, a conveyance path R along which the original P can move is formed between the first transmission plate 21a and the second transmission plate 26a. The original P moves along the conveyance path R in the direction of arrow Y3 while being supported by the first transmission plate 21a and the second transmission plate 26a.

The first light-source unit 22 is provided in the first unit housing 21. The second light-source unit 27 is provided in the second unit housing 26. The first light-source unit 22 emits a light T10 towards the conveyance path R. If the original P is present in the conveyance path R, the first light-source unit 22 emits the light T10 towards the printed front surface P1 of the original P. At this time, a light T11 reflected by the printed front surface P1 is guided to the first lens 23 explained later. If the original P is not present in the conveyance path R, the light T10 emitted by the first light-source unit 22 is guided to the second lens 28 explained later. When viewed from the second image sensor 29, the light T10 is a direct light. It should be noted that the direct light includes a light reflected by a mirror or by a prism so as to be guided to the second image sensor 29.

The second light-source unit 27 emits a light T20 towards the conveyance path R. If the original P is present in the conveyance path R, the second light-source unit 27 emits the light T20 towards the printed rear surface P2 of the original P. At this time, a light T21 reflected by the printed rear surface P2 is guided to the second lens 28 explained later. If the original P is not present in the conveyance path R, the light T20 emitted by the second light-source unit 27 is guided to the first lens 23 explained later. When viewed from the first image sensor 24, the light T20 is a direct light. It should be noted that the direct light includes a light reflected by a mirror or by a prism so as to be guided to the first image sensor 24.

The first light-source unit 22 and the second light-source unit 27 include an R-light source, a G-light source, a B-light source, and a prism, not shown, respectively. The R-light source is turned on to emit a red light. The G-light source is turned on to emit a green light. The B-light source is turned on to emit a blue light. The B-light source, the G-light source, ad the B-light source (hereinafter, sometimes simply called “light sources”) are, for example, LED (light-emitting diode). The light sources are driven by the light-source drive circuit 18 explained later. The prism is provided between each of the light sources and the conveyance path R. The prism is for use to evenly guide the light T10 or the light T20 emitted by the light sources along the main scanning direction of the conveyance path R. If the original P is present in the conveyance path R, the lights T10 of the colors emitted from the light sources are guided to the first transmission plate 21a through the prisms respectively, and further transmit the first transmission plate 21a to be evenly guided to the main scanning direction of the printed front surface P1. In addition, if the original P is present in the conveyance path R, the lights T20 of the colors emitted from the light sources are guided to the second transmission plate 26a through the prisms respectively, and further transmit the second transmission plate 26a to be evenly guided to the main scanning direction of the printed rear surface P2.

The first lens 23 and the first image sensor 24 are provided in the first unit housing 21. The first lens 23 is provided between the first transmission plate 21a and the first image sensor 24. Guided to the first lens 23 are the light T11 emitted by the first light-source unit 22 and reflected by the printed front surface P1 and the light T20 emitted by the second light-source unit 27 and not reflected by the printed rear surface P2. The first lens 23 causes the guided lights to enter the first image sensor 24. The first lens 23 is, for example, a rod lens array. The lights of the light sources reflected by the printed front surface P1 of the original P pass through the first lens 23, and the first lens 23 thereby causes the lights to be formed as an elected image of the printed front surface P1 at its original size on a line sensor of the first image sensor 24.

The second lens 28 and the second image sensor 29 are provided in the second unit housing 26. The second lens 28 is provided between the second transmission plate 26a and the second image sensor 29. Guided to the second lens 28 are the light T21 emitted by the second light-source unit 27 and reflected by the printed rear surface P2 and the light T10 emitted by the first light-source unit 22 and not reflected by the printed front surface P1. The second lens 28 causes the guided lights to enter the second image sensor 29. The second lens 28 is, for example, a rod lens array. The lights of the light sources reflected by the printed rear surface P2 of the original P pass through the second lens 28, and the second lens 28 thereby causes the lights to be formed as an elected image of the printed rear surface P2 at its original size on a line sensor of the second image sensor 29.

The first image sensor 24 picks up an image of the printed front surface P1 of the original P conveyed by the conveying device 11. The second image sensor 29 picks up an image of the printed rear surface P2 of the original P conveyed by the conveying device 11. The first image sensor 24 and the second image sensor 29 have sensor elements (imaging elements) (not shown) linearly arranged. In the first embodiment, the sensor elements of the first image sensor 24 and of the second image sensor 29 are aligned in one line in the main scanning direction of the original P present in the conveyance path R. Each of the sensor elements generates element data, upon each exposure, according to the light incident thereon through the first lens 23 or the second lens 28. In other words, each of the first image sensor 24 and the second image sensor 29 generates a line image, upon each exposure, composed of the element data generated correspondingly to each of the sensor elements. Thus, in the first image sensor 24 and the second image sensor 29, the sensor elements linearly aligned in one line read the original P along the main scanning direction.

The motor drive circuit 17 is a circuit (electronic device) for driving the conveying-roller motor 14. More specifically, the motor drive circuit 17 adjusts a timing of rotating the conveying-roller motor 14 and an angle of rotating the conveying-roller motor 14. Consequently, the motor drive circuit 17 adjusts a timing of rotating the conveying roller 12 and an angle of rotating the conveying roller 12. That is, the motor drive circuit 17 adjusts the timing of conveying the original P and a conveying amount of the original P. The light-source drive circuit 18 is a circuit (electronic device) for driving the light sources of the first light-source unit 22 and the second light-source unit 27. More specifically, the light-source drive circuit 18 separately adjusts timings of turning on and off the light sources of the first light-source unit 22 and timings of turning on and off the light sources of the second light-source unit 27.

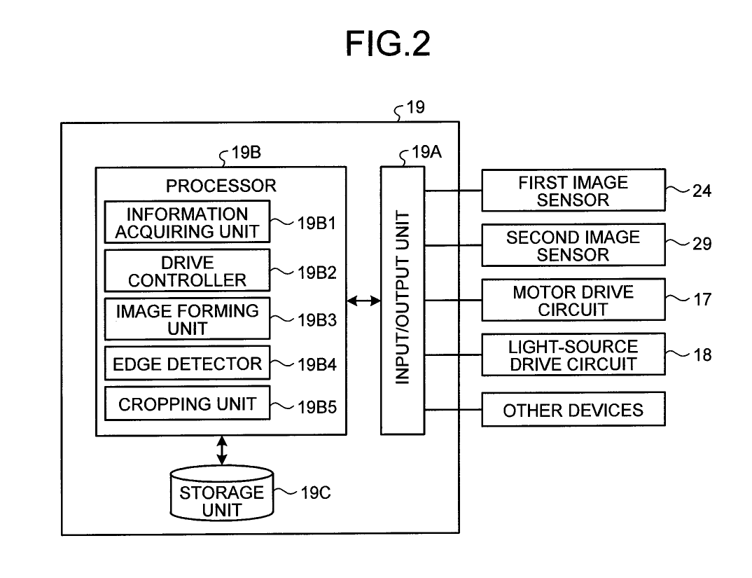

FIG. 2 is a functional block diagram of a control unit. The control unit 19 causes the first imaging unit 20 to read the printed front surface P1 and causes the second imaging unit 25 to read the printed rear surface P2. Moreover, the control unit 19 forms RGB read image data corresponding to the printed front surface P1 and the printed rear surface P2 of the original P. The control unit 19 includes an input/output unit 19A, a processor 19B, and a storage device 19C. The processor 19B is electrically connected to the input/output unit 19A and the storage device 19C. Furthermore, in the control unit 19, the first image sensor 24, the second image sensor 29, the motor drive circuit 17, and the light-source drive circuit 18 are electrically connected to other devices through the input/output unit 19A. The other devices are, for example, an input device and an output device. The input device is used to issue a start instruction of reading the original P by the image reading apparatus 10, issue a control instruction of the image reading apparatus 10 such as read resolution of the original P by the image reading apparatus 10, and perform entry of data. More specifically, the input device includes such input devices as a switch, a keyboard, a mouse, and a microphone. The output device is a CRT (cathode ray tube), a liquid-crystal display device, a printer, or the like.

The processor 19B includes memories such as a RAM and a ROM, and a CPU (central processing unit). The processor 19B loads the control procedure of the image reading apparatus 10 explained later into the memory of the processor 19B at the time of reading the original P by the first image sensor 24 and the second image sensor 29, to perform computation. The processor 19B records a numerical value in the storage device 19C as necessary during the computation, and takes out the recorded numerical value from the storage device 19C as required to perform computation. The processor 19B includes at least an information acquiring unit 19B1, a drive controller 19B2, an image forming unit 19B3, an edge detector 19B4, and a cropping unit 19B5.

The information acquiring unit 19B1 acquires signals from the first image sensor 24 and the second image sensor 29 through the input/output unit 19A. The drive controller 19B2 controls the drive of the conveying-roller motor 14 through the motor drive circuit 17 depicted in FIG. 1 and the drive of the first light-source unit 22 and the second light-source unit 27 through the light-source drive circuit 18. The image forming unit 19B3 depicted in FIG. 2 forms RGB read image data of the printed front surface P1 and the printed rear surface P2 based on the signals acquired from the first image sensor 24 and the second image sensor 29 through the input/output unit 19A. The edge detector 19B4 detects an edge included in the RGB read image data formed by the image forming unit 19B3. The edge mentioned here represents a portion corresponding to an outline of the printed front surface P1 or of the printed rear surface P2, of the RGB read image data formed by the image forming unit 19B3. The cropping unit 19B5 cuts out a cut-out image of the printed front surface P1 or of the printed rear surface P2 from the RGB read image data formed by the image forming unit 19B3, based on the edge detected by the edge detector 19B4.

The storage device 19C records a control program with the control procedure of the image reading apparatus 10 incorporated therein. The storage device 19C is a fixed disk drive such as a hard disk drive; a nonvolatile memory such as a flexible disk, a magneto-optical disc drive, and a flash memory; and a volatile memory such as a RAM (random access memory). Alternatively, the storage device 19C is configured in a combination of these devices. It should be noted that the storage device 19C is not provided separately from the processor 19B but may be provided inside the processor 19B. Moreover, the storage device 19C may be provided in any device (e.g., database server) other than the control unit 19. Next, a control procedure executed by the control unit 19 will be explained below. The control procedure explained as follows is not limited to one configured necessarily as a single unit, and thus, the function may be implemented by the control procedure in cooperation with another computer program typified by OS (operating system).

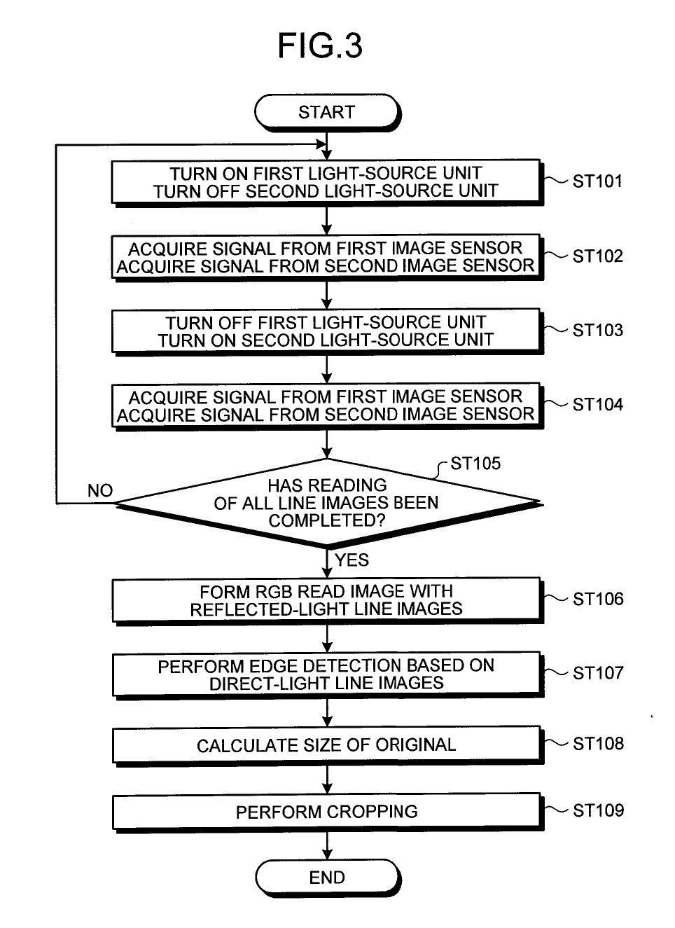

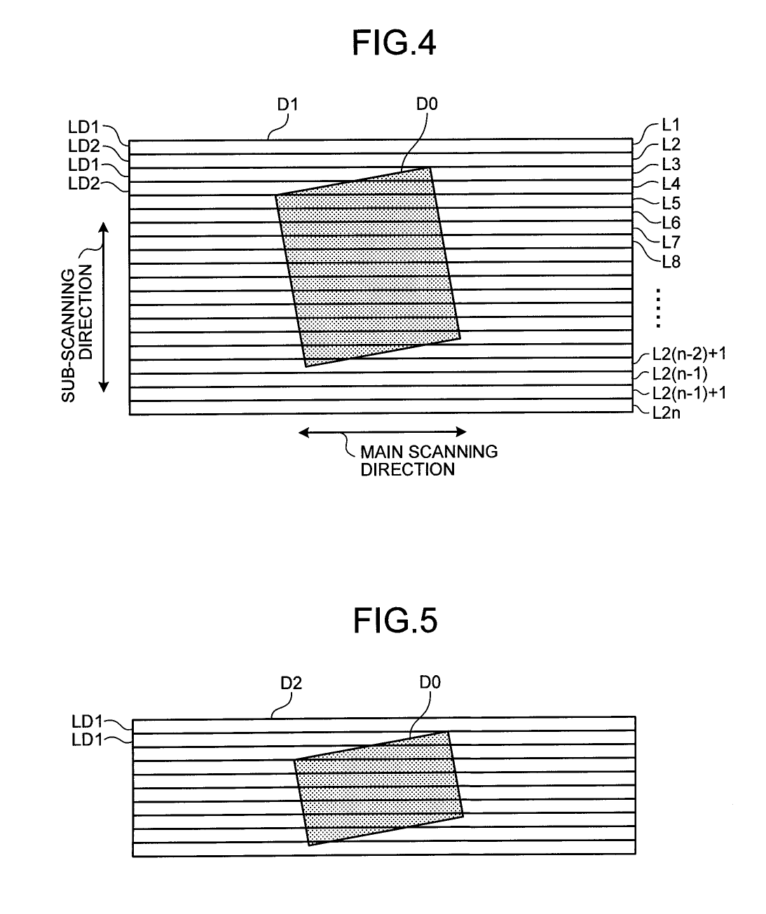

FIG. 3 is a flowchart of a control procedure according to the first embodiment. FIG. 4 is an explanatory diagram schematically representing RGB read image data according to the first embodiment. The control procedure explained as follows is executed during conveyance of the original P by the conveying device 11. At Step ST101 depicted in FIG. 3, the drive controller 19B2 turns on the first light-source unit 22 and turns off the second light-source unit 27. Next, at Step ST102, the information acquiring unit 19B1 acquires signals from the first image sensor 24 and the second image sensor 29. These signals correspond to line images. The storage device 19C stores therein the acquired signals associated with position information for read portions of the signals in a sub-scanning direction. Here, the image reading apparatus 10 picks up line images plural times along the sub-scanning direction. This allows the image reading apparatus 10 to read the image by being separated into a plurality of lines as depicted in FIG. 4. The line extends in the main scanning direction and a plurality of lines is arranged in the sub-scanning direction. The position information for the read portion in the sub-scanning direction is information indicating to which line the read portion corresponds.

Next, at Step ST103, the drive controller 19B2 turns off the first light-source unit 22 and turns on the second light-source unit 27. Next, at Step ST104, the information acquiring unit 19B1 acquires signals from the first image sensor 24 and the second image sensor 29. The storage device 19C stores therein the acquired signals associated with position information for read portions of the signals in the sub-scanning direction. As explained above, by executing a series of steps from Step ST101 to Step ST104, the processor 19B alternately turns on the first light-source unit 22 and the second light-source unit 27 to acquire the line image from the first image sensor 24. With this feature, the second light-source unit 27 does not guide the direct light to the first image sensor 24 while the first image sensor 24 is taking images for image formation.

Here, an RGB read image D1 depicted in FIG. 4 is formed based on a plurality of line images acquired from the first image sensor 24. The procedure from acquiring the line images from the first image sensor 24 to forming the RGB read image D1 including an image of the printed front surface P1 (hereinafter, “cut-out image D0”) will be explained below.

The RGB read image D1 includes two types of line images: a reflected-light line image LD1 as an image for image formation and a direct-light line image LD2 as an image for edge detection. The reflected-light line image LD1 is an image picked up when the light T10 emitted from the first light-source unit 22 depicted in FIG. 1 is reflected by the printed front surface P1 to be guided to the first image sensor 24. The light T11 guided to the first image sensor 24 is a light reflected by the printed front surface P1 when the original P is present in the conveyance path R, while it is a light reflected by, for example, a backing sheet when the original P is not present in the conveyance path R. In other words, the information acquiring unit 19B1 acquires the reflected-light line images LD1 at Step ST102.

The direct-light line image LD2 is an image picked up when the light T20 emitted from the second light-source unit 27 depicted in FIG. 1 is guided to the first image sensor 24. The light T20 guided to the first image sensor 24 is a light having transmitted the original P when the original P is present in the conveyance path R, while it is a light directly guided from the second light-source unit 27 thereto when the original P is not present in the conveyance path R. In other words, the information acquiring unit 19B1 acquires the direct-light line images LD2 at Step ST104. The RGB read image D1 has the reflected-light line image LD1 and the direct-light line image LD2 which are alternately arranged in the sub-scanning direction. The control unit 19 repeatedly executes a series of steps from Step ST101 to Step ST104, to thereby store the reflected-light line images LD1 and the direct-light line images LD2 in the storage device 19C.

Next, at Step ST105, the processor 19B determines whether reading of all the preset line images has been completed. It should be noted that the total number of lines changes depending on image quality of an image to be formed by the image reading apparatus 10 and a maximum size of the original P which can be read by the image reading apparatus 10 or the like. If the reading of all the line images has not been completed (No at Step ST105), the processor 19B returns to Step ST101. When the reading of all the line images has been completed (Yes at Step ST105), the processor 19B proceeds to Step ST106. Here, the step of forming a cut-out image of the printed front surface P1 and the step of forming a cut-out image of the printed rear surface P2 are similar to each other. Therefore, the step of forming the cut-out image of the printed front surface P1 will be explained below.

FIG. 5 is an explanatory diagram schematically representing an RGB read image according to the first embodiment formed with the reflected-light line images. At Step ST106, the image forming unit 19B3 forms an RGB read image D2 with reduced show-through as depicted in FIG. 5. More specifically, the image forming unit 19B3 acquires the reflected-light line images LD1 from the storage device 19C. As explained above, the reflected-light line image LD1 is an image being a line obtained when the first light-source unit 22 is turned on, among a plurality of lines depicted in FIG. 4, and being acquired from the first image sensor 24. In the first embodiment, odd-number lines depicted in FIG. 4 [L1, L3, L5, . . . L2(n−2)+1, L2(n−1)+1] are lines obtained when the first light-source unit 22 is turned on. The image forming unit 19B3 arranges the reflected-light line images LD1, being these odd-number lines acquired from the first image sensor 24, in their orders in the sub-scanning direction so as not to be spaced from each other, and thus forms the RGB read image D2 depicted in FIG. 5.

Here, when the first light-source unit 22 is turned on, the second light-source unit 27 is turned off. Therefore, the reflected-light line image LD1 acquired from the first image sensor 24 when the first light-source unit 22 is turned on is an image obtained when the second light-source unit 27 is turned off. Thus, the image is an image when the light T20 is not supplied to the printed rear surface P2. With this feature, the reflected-light line image LD1 is an image in which show-through is suppressed. The image forming unit 19B3 forms the RGB read image D2 with reduced show-through based on only the reflected-light line images LD1 with suppressed show-through. Next, at Step ST107, the edge detector 19B4 detects an edge of the cut-out image D0 included in the RGB read image D2 formed by the image forming unit 19B3 at Step ST106. How to detect the edge will be explained below.

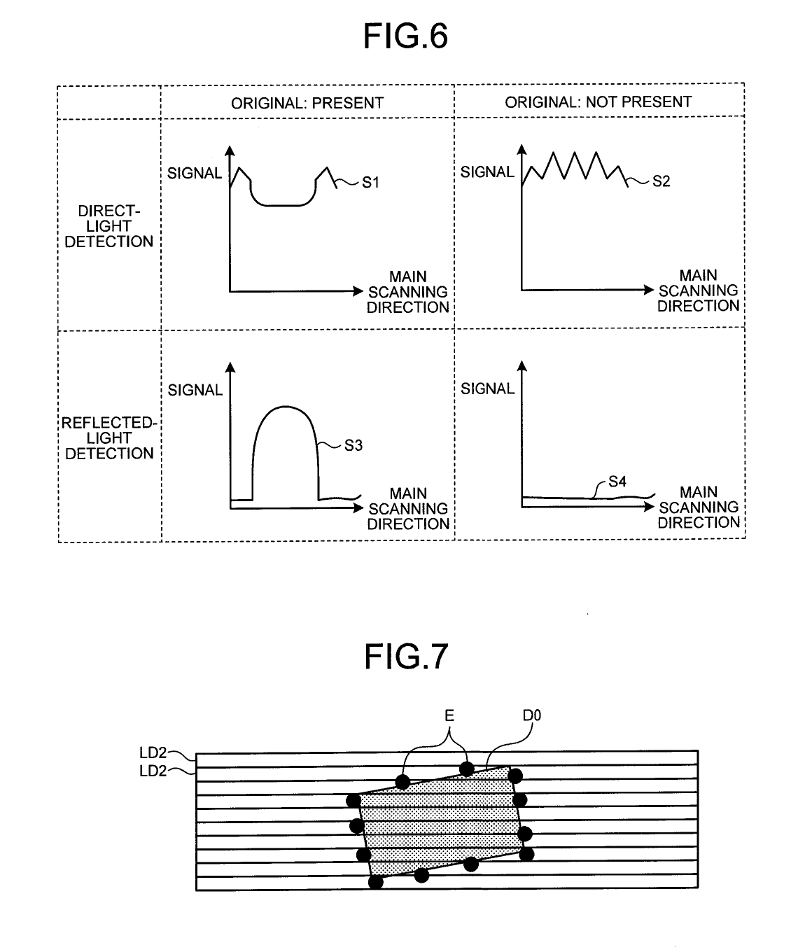

FIG. 6 is an explanatory diagram representing magnitudes of signals output by image sensors depending on whether an original is present or not present. The horizontal axis depicted in FIG. 6 represents a position of the signal in the main scanning direction, and the vertical axis represents the magnitude of a signal output by the first image sensor 24. The direct-light detection is edge detection using the light T20 incident on the first image sensor 24 from the second light-source unit 27. The reflected-light detection is edge detection using the light T11 emitted from the first light-source unit 22, reflected by the printed front surface P1, and incident on the first image sensor 24. As depicted in FIG. 6, in the image sensor, signals to be output change depending on whether the original P is present in the conveyance path R.

More specifically, in the direct-light detection, when the original P is present in the conveyance path R, a signal S1 at a portion where the original P is present decreases than a maximum value. Meanwhile, when the original P is not present in the conveyance path R, a signal S2 does not decrease from the maximum value. The edge detector 19B4 performs edge detection of the original P based on the change in the magnitude of the signal (S1, S2). It should be noted that in the reflected-light detection, when the original P is present in the conveyance path R, a signal S3 at a portion where the original P is present increases than a minimum value. Meanwhile, when the original P is not present in the conveyance path R, a signal S4 does not increase from the maximum value. The edge detector 19B4 can also perform edge detection of the original P based on the change of the signal (S3, S4).

FIG. 7 is an explanatory diagram schematically representing edge detection according to the first embodiment by an edge detector. The edge detector 19B4 acquires the direct-light line image LD2 from the storage device 19C. As explained above, the direct-light line images LD2 are images being lines obtained when the second light-source unit 27 is turned on, among a plurality of lines depicted in FIG. 4, and being acquired from the first image sensor 24. In the first embodiment, even-number lines depicted in FIG. 4 [L2, L4, L6, . . . L2(n−1), L2n] are lines obtained when the second light-source unit 27 is turned on. The direct-light line image LD2 is an image picked up by the first image sensor 24 when the light T20 being the direct light for the first image sensor 24 is incident on the first image sensor 24. The light T20 includes one transmitting a portion where the original P is present and passing through a portion where the original P is not present. This causes the signal S1 of the first image sensor 24 to change as depicted in FIG. 6. The edge detector 19B4 detects positions of the edges E of the cut-out image D0 depicted in FIG. 7 based on the change of the signal S1.

Here, the image reading apparatus 10 can also perform edge detection by the reflected-light detection. However, the image reading apparatus 10 according to the first embodiment is characterized in that the edge detection is performed by the direct-light detection. In the reflected-light detection, the accuracy of edge detection changes depending on the reflectivity of the printed front surface P1 or of the printed rear surface P2. For example, if a difference between the reflectivity of the printed front surface P1 and the reflectivity of a backing material (e.g., white reference sheet for calibration) is particularly small, the accuracy of the edge detection is thought to be decreased in the reflected-light detection.

However, the image reading apparatus 10 according to the first embodiment performs edge detection using the direct-light detection. As described above, the direct-light detection is a method of detecting an edge of the original P based on whether the original P is present between the light source unit and the image sensor which are opposed to each other across the conveyance path R. Therefore, the direct-light detection is hard to be dependent on the reflectivity of the printed front surface P1 or of the printed rear surface P2, and variation in the accuracy of edge detection can thereby be reduced. Thus, the image reading apparatus 10 can improve the accuracy of the edge detection. It should be noted that the edge detection by the edge detector 19B4 is not limited to the edge detection based on the signal acquired from the first image sensor 24. The edge detector 19B4 may perform edge detection based on the signal acquired from the second image sensor 29. In this case, the edge detector 19B4 acquires a signal (reflected-light line image LD1), being the line obtained when the second light-source unit 27 is turned on and being acquired from the second image sensor 29, from the storage device 19C. The edge detector 19B4 detects the positions of edges E of the original P depicted in FIG. 7 based on the change in the magnitude of the signal.

Next, at Step ST108, the cropping unit 19B5 calculates a size of the cut-out image from the RGB read image D2 depicted in FIG. 5 or a size of the original P based on the position information of the edges E depicted in FIG. 7. Next, at Step ST109, the cropping unit 19B5 cuts out (crops) the cut-out image D0 from the RGB read image D2 depicted in FIG. 5 with the size calculated at Step ST108. The processor 19B executes Step ST109 and ends the execution of the control procedure. Before the execution of the control procedure is ended, the processor 19B may store the cropped cut-out image D0 in the storage device 19C or may output the cropped cut-out image D0 to the output device.

Here, when the image reading apparatus 10 is to read the printed rear surface P2, at Step ST106 depicted in FIG. 3, the image forming unit 19B3 forms the RGB read image D2 depicted in FIG. 5 based on the reflected-light line images LD1 acquired from the second image sensor 29. At Step ST107, the edge detector 19B4 performs edge detection based on the direct-light line images LD2 acquired from the second image sensor 29. Thus, the image reading apparatus 10 can read the printed rear surface P2. It should be noted that the image reading apparatus 10 can simultaneously read the printed front surface P1 and the printed rear surface P2.

The processor 19B executes the control procedure, and the image reading apparatus 10 can thereby implement the edge detection by the direct-light detection based on the configuration in which a pair of imaging units is oppositely provided across the conveyance path R. Higher accuracy than that of edge detection by the reflected-light detection is expected in the edge detection by the direct-light detection. Thus, the image reading apparatus 10 can improve the accuracy of the edge detection. Furthermore, the image reading apparatus 10 does not use the direct-light line images LD2 with show-through for formation of the cut-out image D0. Therefore, the image reading apparatus 10 can also reduce the show-through.

Here, the image reading apparatus 10 according to the first embodiment forms the RGB read image D2 depicted in FIG. 5 using only the reflected-light line images LD1 depicted in FIG. 4, and uses the direct-light line images LD2 for edge detection. Thus, in the image reading apparatus 10, the number of line images to be acquired is increased by an amount of the direct-light line image LD2 than that in the case where the edge detection is not performed. Therefore, it is preferred that the control unit 19 reduce a conveying speed of the original P by the conveying device 11 depicted in FIG. 1 than that in the case where the edge detection is not performed. Thus, the image reading apparatus 10 can suppress degradation of image quality of the cut-out image D0. In the first embodiment, the control unit 19 reduces the conveying speed to one-half of the conveying speed in the case where the edge detection is not performed. Thus, the image reading apparatus 10 can form the cut-out image D0 in which degradation of the image quality is suppressed.

However, the image reading apparatus 10 can improve a reading speed on the whole. For example, there is a technology of separately illuminating the R light, the G light, and the B light for the purpose of reducing the show-through (Patent document 1: Japanese Laid-open Patent Publication No. 2007-166213). This technology is configured to separately illuminate the R light, the G light, and the B light, and acquire a line image from the image sensor upon each illumination. Thus, the technology needs to set the conveying speed of the original P to one-third as compared with a case in which the R light, the G light, and the B light are simultaneously emitted from the light-source units. However, the image reading apparatus 10 according to the first embodiment can reduce the show-through even if the R light, the G light, and the B light are simultaneously emitted from the light-source units. More specifically, the image reading apparatus 10 can reduce the show-through even if the conveying speed of the original P is set to one-half. As a result, the image reading apparatus 10 can read the original P at a speed of 3/2 times of the technology for separately illuminating the R light, the G light, and the B light.

For example, when the original P with a printed surface on one side thereof is to be read, the image reading apparatus 10 can read the original P at a speed equivalent to that of the case where edge detection is not performed. In this case, the direct-light line images LD2 depicted in FIG. 4 are data for the image without show-through. Therefore, the control unit 19 forms the RGB read image D2 depicted in FIG. 5 based on both the reflected-light line image LD1 and the direct-light line image LD2. At this time, the control unit 19 can set the conveying speed of the original P by the conveying device 11 to a value equivalent to that of the case where edge detection is not performed. In this manner, the image reading apparatus 10 can also suppress decrease of the reading speed of the original P. In this case, the reading speed in the image reading apparatus 10 becomes three times as fast as the reading speed due to the technology for separately illuminating the R light, the G light, and the B light.

### FIRST MODIFIED EXAMPLE

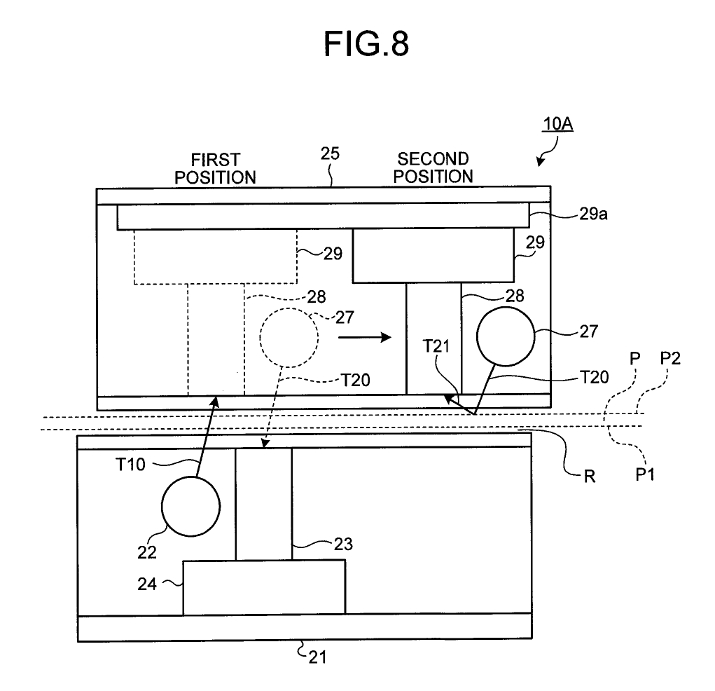

FIG. 8 is an explanatory diagram schematically representing an image reading apparatus according to a first modified example. An image reading apparatus 10A according to the first modified example depicted in FIG. 8 can implement the same functions as these of the image reading apparatus 10 according to the first embodiment without repetition of turning on and off by the second light-source unit 27. Hereinafter, the same numerals are assigned to the same components as these of the image reading apparatus 10 according to the first embodiment depicted in FIG. 1, and detailed explanation thereof is omitted.

The image reading apparatus 10A further includes a moving device 29a in addition to the components provided in the image reading apparatus 10 according to the first embodiment depicted in FIG. 1. The moving device 29a is for use to move the second light-source unit 27, the second lens 28, and the second image sensor 29, as one unit, in the sub-scanning direction. The moving device 29a moves the second light-source unit 27, the second lens 28, and the second image sensor 29 from a first position to a second position. The first position is a position where the light T10 emitted from the first light-source unit 22 can be guided to the second lens 28 and the light T20 emitted from the second light-source unit 27 can be guided to the first lens 23. The second position is a position where the light T10 emitted from the first light-source unit 22 cannot be guided to the second lens 28 and the light T20 emitted from the second light-source unit 27 cannot be guided to the first lens 23.

The control unit 19 of the image reading apparatus 10A moves the second light-source unit 27, the second lens 28, and the second image sensor 29 from the first position to the second position instead of turning off the first light-source unit 22 and the second light-source unit 27. When the second light-source unit 27, the second lens 28, and the second image sensor 29 are located at the first position, the information acquiring unit 19B1 acquires the direct-light line image LD2 depicted in FIG. 4. When the second light-source unit 27, the second lens 28, and the second image sensor 29 are located at the second position, the information acquiring unit 19B1 acquires the reflected-light line image LD1.

The image reading apparatus 10A may acquire the direct-light line image LD2 required for edge detection when the second light-source unit 27, the second lens 28, and the second image sensor 29 are located at the first position, and may acquire the reflected-light line image LD1 required for formation of the cut-out image D0 when the second light-source unit 27, the second lens 28, and the second image sensor 29 are located at the second position. As a result, the image reading apparatus 10A has the same effect as that of the image reading apparatus 10 according to the first embodiment.

### Second Embodiment

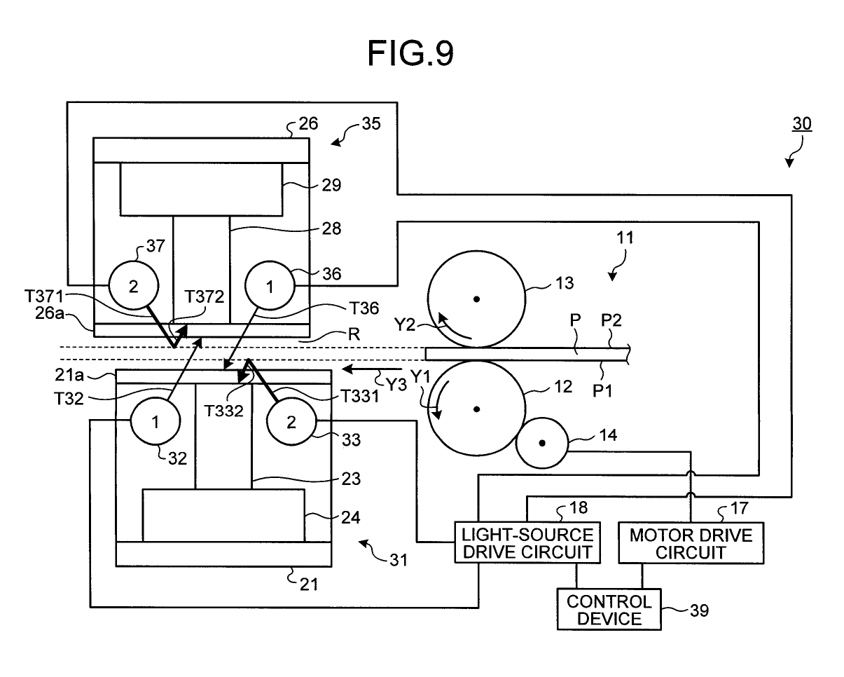

FIG. 9 is an explanatory diagram schematically representing an image reading apparatus according to a second embodiment. Hereinafter, the same reference numerals are assigned to the same components as these of the image reading apparatus 10 according to the first embodiment depicted in FIG. 1, and detailed explanation thereof is omitted. An image reading apparatus 30 according to the second embodiment includes, as depicted in FIG. 9, a first imaging unit 31, a second imaging unit 35, and a control unit 39. The first imaging unit 31 and the second imaging unit 35 are provided mutually opposite to each other. The conveyance path R is provided between the first imaging unit 31 and the second imaging unit 35. The first imaging unit 31 reads the printed front surface P1 of the original P. The second imaging unit 35 reads the printed rear surface P2 of the original P.

The first imaging unit 31 includes the first unit housing 21, the first transmission plate 21a, a front-side first light-source unit 32, a front-side second light-source unit 33, the first lens 23, and the first image sensor 24. The second imaging unit 35 includes the second unit housing 26, the second transmission plate 26a, a rear-side first light-source unit 36, a rear-side second light-source unit 37, the second lens 28, and the second image sensor 29. The front-side first light-source unit 32 and the front-side second light-source unit 33 are provided in the first unit housing 21. The front-side first light-source unit 32 and the front-side second light-source unit 33 are provided, for example, across the first lens 23 in the sub-scanning direction. The rear-side first light-source unit 36 and the rear-side second light-source unit 37 are provided in the second unit housing 26. The rear-side first light-source unit 36 and the rear-side second light-source unit 37 are provided, for example, across the second lens 28 in the sub-scanning direction.

The front-side first light-source unit 32 emits a light T32 toward the conveyance path R. When the original P is not present in the conveyance path R, the light T32 is guided to the second lens 28 of the second imaging unit 35. When the original P is present in the conveyance path R, the light T32 transmits the original P to be guided to the second lens 28. The front-side second light source unit 33 emits a light T331 toward the conveyance path R. When the original P is present in the conveyance path R, the light T331 is reflected by the printed front surface P1. A light T332 reflected by the printed front surface P1 is guided to the first lens 23 of the first imaging unit 31. The front-side first light-source unit 32 and the front-side second light-source unit 33 are provided at positions where the lights can be guided to the image sensors respectively in the above manner.

The rear-side first light-source unit 36 emits a light T36 toward the conveyance path R. When the original P is not present in the conveyance path R, the light T36 is guided to the first lens 23 of the first imaging unit 31. When the original P is present in the conveyance path R, the light T36 transmits the original P to be guided to the first lens 23. The rear-side second light-source unit 37 emits a light T371 toward the conveyance path R. When the original P is present in the conveyance path R, the light T371 is reflected by the printed rear surface P2. A light T372 reflected by the printed rear surface P2 is guided to the second lens 28 of the second imaging unit 35. The rear-side first light-source unit 36 and the rear-side second light-source unit 37 are provided at positions where the lights can be guided to the image sensors respectively in the above manner.

The control unit 39 is electrically connected to the front-side first light-source unit 32, the front-side second light-source unit 33, the rear-side first light-source unit 36, and the rear-side second light-source unit 37 through the light-source drive circuit 18. With this connection, the control unit 39 separately controls timing of turning on and off the front-side first light-source unit 32, the front-side second light-source unit 33, the rear-side first light-source unit 36, and the rear-side second light-source unit 37. It should be noted that the rest of the configuration of the control unit 39 is the same as that of the control unit 19 depicted in FIG. 1.

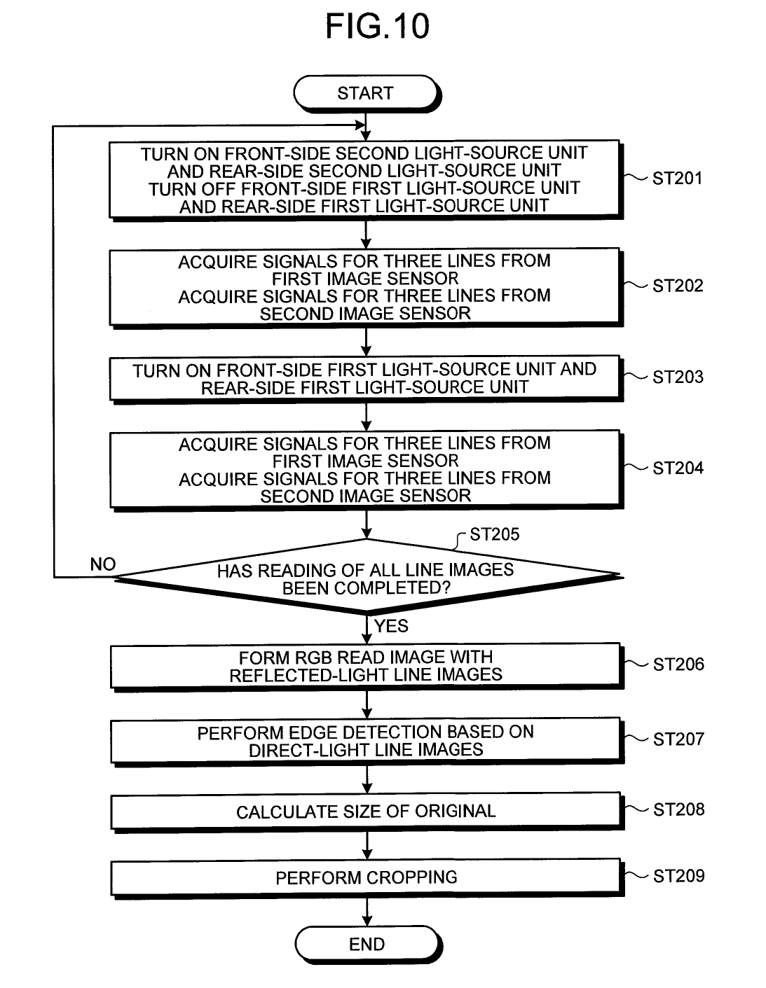

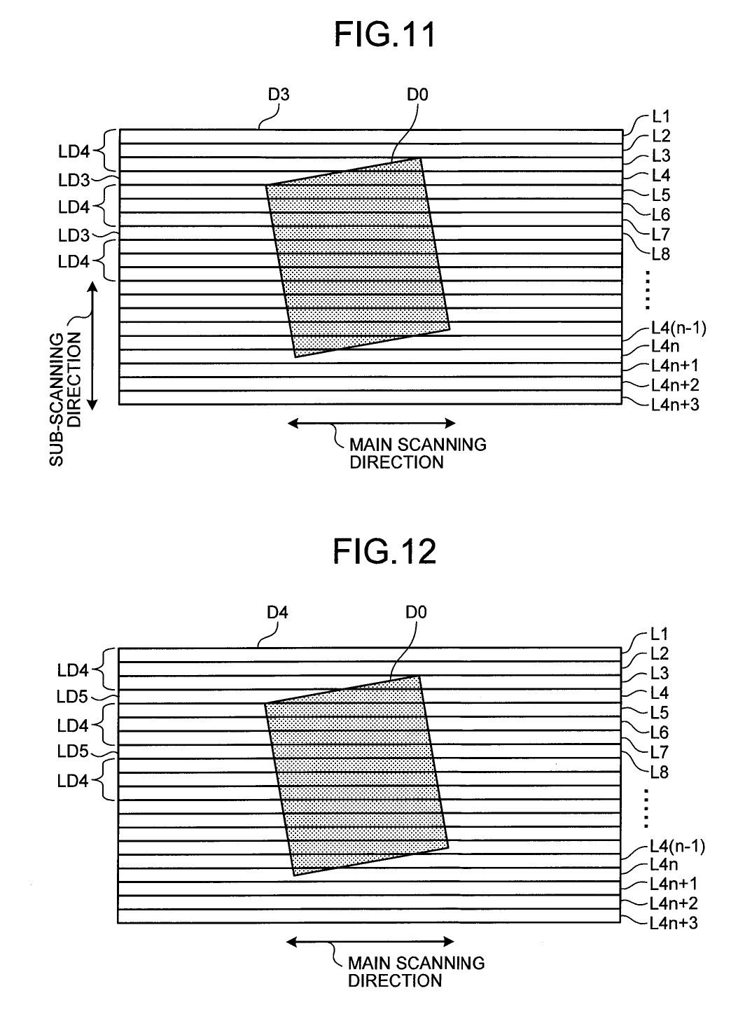

FIG. 10 is a flowchart of a control procedure according to the second embodiment. FIG. 11 is an explanatory diagram schematically representing RGB read image data according to the second embodiment. The control procedure explained as follows is executed during conveyance of the original P by the conveying device 11.

At Step ST201 depicted in FIG. 10, the drive controller 19B2 turns on the front-side second light-source unit 33 and the rear-side second light-source unit 37, and turns off the front-side first light-source unit 32 and the rear-side first light-source unit 36. Next, at Step ST202, the information acquiring unit 19B1 acquires signals for, for example, three lines from the first image sensor 24 and the second image sensor 29. The signals acquired by the information acquiring unit 19B1 are not limited to these for three lines, and thus one line or more is required for the signal. The signal corresponds to a line image. The storage device 19C stores the acquired signal associated with the position information of a portion read for each line in the sub-scanning direction. Here, as depicted in FIG. 11, the image reading apparatus 30 reads an image by being separated into a plurality of lines.

Next, at Step ST203, the drive controller 19B2 turns on the front-side first light-source unit 32 and the rear-side first light-source unit 36. It should be noted that at Step ST203, the drive controller 19B2 may turn off the front-side second light-source unit 33 and the rear-side second light-source unit 37 or may keep them turned on. Next, at Step ST204, the information acquiring unit 19B1 acquires signals from the first image sensor 24 and the second image sensor 29. The signals correspond to line images. The storage device 19C stores the acquired signal associated with the position information of a read portion in the sub-scanning direction. In this manner, the processor 19B executes a series of steps from Step ST201 to Step ST205, to cause the front-side first light-source unit 32 and the rear-side first light-source unit 36 to turn on once in three lines.

Here, an RGB read image D3 depicted in FIG. 11 is formed based on a plurality of line images acquired from the first image sensor 24. Hereinafter, there is explained how to acquire line images from the first image sensor 24 and form the RGB read image D3 including the cut-out image D0. The RGB read image D3 includes two types of line images: a direct-light line image LD3 and a reflected-light line image LD4. The direct-light line image LD3 is data generated when a light T36 emitted from the rear-side first light-source unit 36 depicted in FIG. 9 is guided to the first image sensor 24. The light T36 guided to the first image sensor 24 is a direct light when viewed from the first image sensor 24. The light T36 transmits the original P when the original P is present in the conveyance path R, and is directly guided from the rear-side first light-source unit 36 when the original P is not present in the conveyance path R. The information acquiring unit 19B1 acquires the direct-light line image LD3 for one line at Step ST204.

The reflected-light line image LD4 is data generated when the light T332 emitted from the front-side second light-source unit 33 depicted in FIG. 9 is guided to the first image sensor 24. The light guided to the first image sensor 24 is the light T332 reflected by the printed front surface P1 when the original P is present in the conveyance path R, and is the light T332 reflected by the backing sheet when the original P is not present in the conveyance path R. The information acquiring unit 19B1 acquires the reflected-light line images LD4 for three lines at Step ST202. The RGB read image D3 depicted in FIG. 11 is such that the reflected-light line images LD4 for three lines and the direct-light line image LD3 for one line are alternately arranged in the sub-scanning direction. The control unit 39 repeatedly executes a series of steps from Step ST201 to Step ST204, to thereby store the direct-light line images LD3 and the reflected-light line images LD4 in the storage device 19C.

Next, at Step ST205, the processor 19B determines whether reading of all the preset line images has been completed. If reading of all the line images has not been completed (No at Step ST205), then the processor 19B returns to Step ST201. If reading of all the line images has been completed (Yes at Step ST205), then the processor 19B proceeds to Step ST206. Hereinafter, a step of reading the printed front surface P1 of the original P will be explained. In the case of reading the printed rear surface P2, the control unit 39 also executes the same step, so that the printed rear surface P2 can be read.

FIG. 12 is an explanatory diagram schematically representing the RGB read image data according to the second embodiment formed with the reflected-light line images. At Step ST206, the image forming unit 19B3 forms an RGB read image D4 with reduced show-through depicted in FIG. 12. More specifically, the image forming unit 19B3 acquires the reflected-light line image LD4, being lines obtained when the rear-side first light-source unit 36 is turned off among a plurality of lines depicted in FIG. 11 and being acquired from the first image sensor 24, from the storage device 19C. In the second embodiment, lines other than lines in multiples of 4 depicted in FIG. 11 [L4, L8, . . . L4(n−1), L4n+3] are lines obtained when the rear-side first light-source unit 36 is turned off. The image forming unit 19B3 forms the RGB read image D4, as depicted in FIG. 12, in which the reflected-light line images LD4 being the lines other than the lines in multiples of 4 and being acquired from the first image sensor 24 are sequentially arranged in their orders in the sub-scanning direction.

Here, when the reflected-light line images LD4 are acquired, the rear-side first light-source unit 36 is turned off. Therefore, the reflected-light line images LD4 are line images with reduced show-through. The image forming unit 19B3 forms the RGB read image data D4 including the cut-out image D0 based on only the reflected-light line images LD4 with reduced show-through. However, the image data formed herein is image data with missing lines in multiples of 4. Therefore, the control unit 39 interpolates the line images in multiples of 4. An example of how to interpolate a missing line image will be explained below.

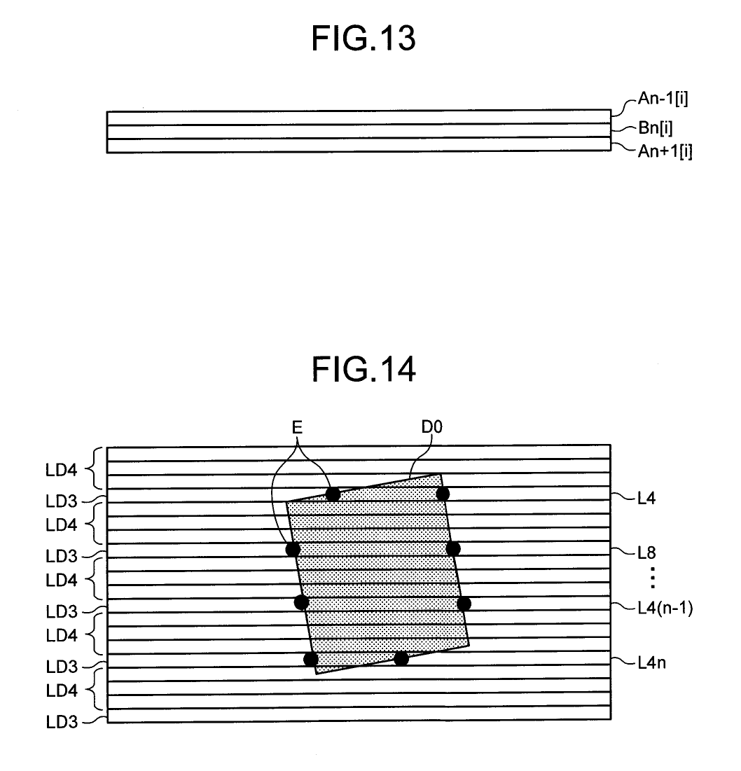

FIG. 13 is an explanatory diagram representing how to interpolate a missing line image. Bn[i] depicted in FIG. 13 is a missing line. An+1[i] and An−1[i] are i-th element data for lines adjacent to the missing line (Bn[i]). In addition, n represents what number line it is, and [i] represents a position thereof in the main scanning direction. The image forming unit 19B3 interpolates Bn[i] by using, for example, linear interpolation. More specifically, the image forming unit 19B3 calculates Bn[i] by substituting An+1[i] and An−1[i] into the following Equation (1). With this calculation, the image forming unit 19B3 interpolates Bn[i] with element data, as element data of Bn[i], obtained by averaging element data of An+1[i] and element data of An−1[i].

Bn[i]=[(An+1[i])+(An−1[i])/2 (1)

Alternatively, the image forming unit 19B3 interpolates Bn[i] also using the direct-light line images LD3. More specifically, the image forming unit 19B3 calculates Bn[i] by substituting An+1[i], An[i], and An−1[i] into the following Equation (2). It should be noted that An[i] is element data for a line when the information acquiring unit 19B1 acquires the direct-light line image LD3. With this calculation, the image forming unit 19B3 interpolates Bn[i] with element data, as element data of Bn[i], obtained by averaging element data of An+1[i], element data of An[i], and element data of An−1[i].

Bn[i]=[(An+1[i])+(An[i])+(An−1[i])]/3 (2)

Alternatively, the image forming unit 19B3 interpolates Bn[i] also using cubic interpolation. More specifically, the image forming unit 19B3 calculates Bn[i] by substituting An+1[i], An+1[i−1], An+1[i+1], An−1[i], An−1[i−1], and An−1[i+1] into the following Equation (3). With this calculation, the image forming unit 19B3 interpolates Bn[i] with element data, as element data of Bn[i], obtained by averaging element data of An+1[i], element data of An+1[i−1], element data of An+1[i+1], element data of An−1[i], element data of An−1[i−1], and element data of An−1[i+1].

Bn[i]=[(An+1[i])+(An+1[i−1])+(An+1[i+1])+(An−1[i])+(An−1[i−1])+(An−1[i+1])]/6 (3)

By using these interpolation methods, the image forming unit 19B3 interpolates the reflected-light line image LD4 having been missed due to picking up of the direct-light line image LD3, based on at least two reflected-light line images LD4 picked up before and after the period at which the first image sensor 24 picks up the direct-light line image LD3. It should be noted that the interpolation method used by the image forming unit 19B3 is not limited to the three methods. The image forming unit 19B3 may interpolate Bn[i] with, for example, An[i] or An−1[i] as element data of Bn[i]. The image forming unit 19B3 determines a set of Bn[i] being a plurality of element data arranged in the sub-scanning direction as an interpolation line image LD5. The image forming unit 19B3 forms the RGB read image D4, as depicted in FIG. 12, based on the reflected-light line images LD4 and the interpolation line images LD5. Next, at Step ST207 depicted in FIG. 10, the edge detector 19B4 detects the edges of the cut-out image D0 included in the RGB read image D4 formed by the image forming unit 19B3 at Step ST206. The method thereof will be explained below.

FIG. 14 is an explanatory diagram schematically representing edge detection according to the second embodiment performed by the edge detector. The edge detector 19B4 acquires the direct-light line image LD3, being a line obtained when the rear-side first light-source unit 36 is turned on among a plurality of lines depicted in FIG. 11 and being acquired from the first image sensor 24, from the storage device 19C. In the second embodiment, the lines in multiples of 4 depicted in FIG. 11 [L4, L8, . . . L4(n−1), L4n+3] are lines obtained when the rear-side first light-source unit 36 is turned on. The direct-light line image LD3 is a signal output when the light T36 enters the first image sensor 24. The light T36 includes one transmitting a portion where the original P is present and one passing through a portion where the original P is not present. With this feature, the signal 1 of the first image sensor 24 changes as depicted in FIG. 6. The edge detector 19B4 detects each position of the edges E of the cut-out image D0 depicted in FIG. 14 based on the change of the signal S1.

Next, the control unit 39 proceeds to Step ST208. It should be noted that Step ST208 and Step ST209 are the same as Step ST108 and Step ST109 depicted in FIG. 3. Thus, explanation of Step ST208 and Step ST209 is omitted. The control unit 39 executes Step ST209, and ends execution of the series of steps. Here, when the image reading apparatus 30 reads the printed rear surface P2, the image forming unit 19B3 forms the RGB read image D4 depicted in FIG. 12 at Step ST206 based on the reflected-light line images LD4 acquired from the second image sensor 29. The edge detector 19B4 performs edge detection at Step ST207 based on the direct-light line images LD3 acquired from the second image sensor 29. Thus, the image reading apparatus 30 can read the printed rear surface P2.

The processor 19B executes the control procedure, and this allows the image reading apparatus 30 to implement edge detection by the direct-light detection based on the configuration in which a pair of imaging units is oppositely provided across the conveyance path R. Higher accuracy than that of edge detection by the reflected-light detection is expected in the edge detection by the direct-light detection. Thus, the image reading apparatus 30 can improve the accuracy of the edge detection. Furthermore, the image reading apparatus 30 does not use the direct-light line images LD2 with show-through for formation of the cut-out image D0. Therefore, the image reading apparatus 30 can also reduce the show-through.

Here, in the image reading apparatus 10 according to the first embodiment, the conveying speed is set to a speed of one-half of the conveying speed when the edge detection is not performed so as not to obtain a missing line image or in order to suppress degradation of image quality. Meanwhile, the image reading apparatus 30 according to the second embodiment forms the cut-out image D0 by performing interpolation without re-reading the missing line image. Thus, the image reading apparatus 30 is expected to obtain the image quality equivalent to that of the image reading apparatus 10 according to the first embodiment even at the same speed as the conveying speed when the edge detection is not performed. As a result, the image reading apparatus 30 can read the original P at a speed three times as fast as that of, for example, the technology for separately emitting the R light, the G light, and the B light.

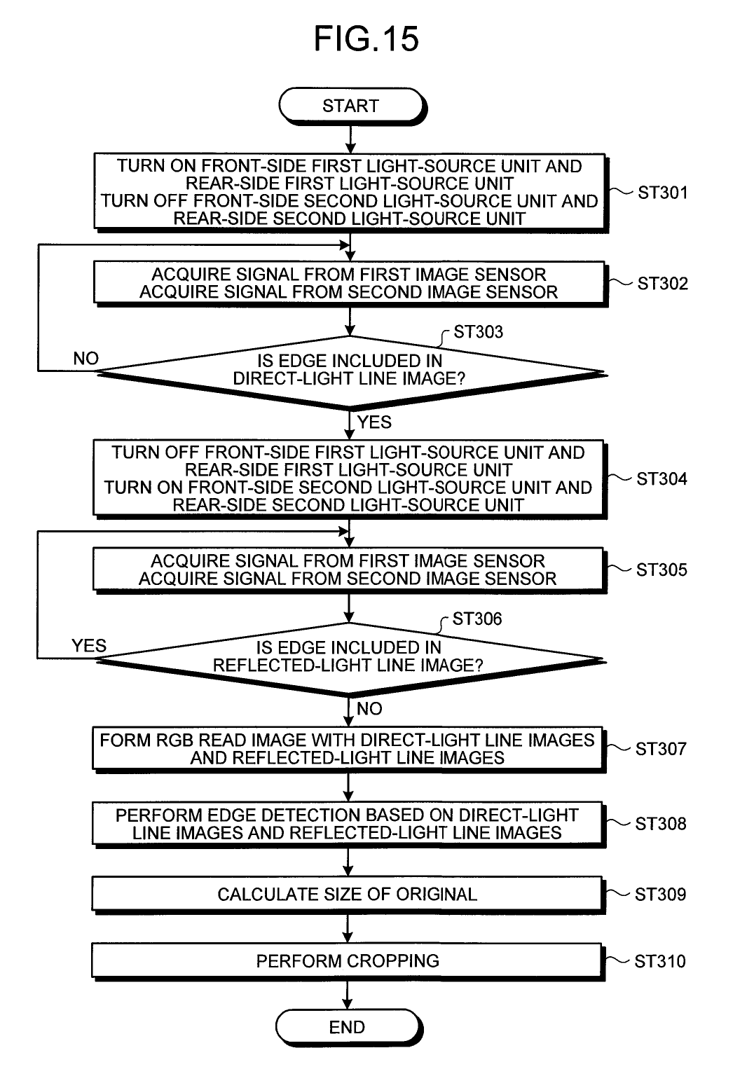

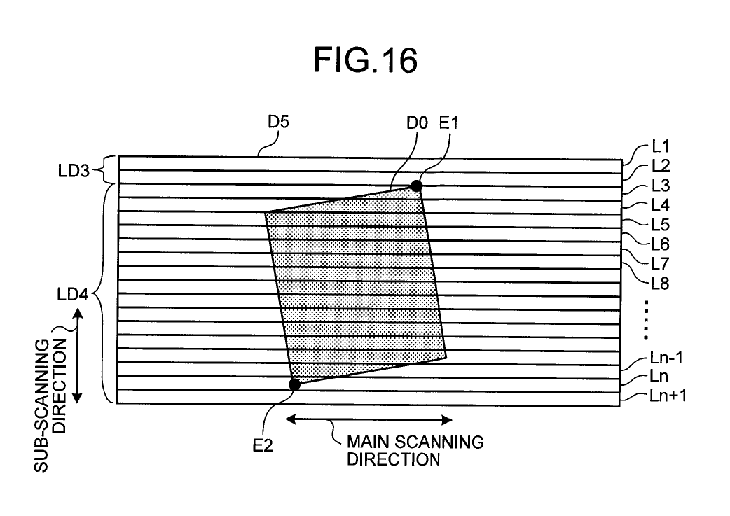

FIG. 15 is a flowchart of a control procedure according to a third embodiment. FIG. 16 is an explanatory diagram schematically representing RGB read image data according to the third embodiment. The image reading apparatus according to the third embodiment has the same configuration as that of the image reading apparatus 30 according to the second embodiment. However, the control procedure executed by the control unit 39 is different from that of the image reading apparatus 30. The control procedure explained as follows is executed during conveyance of the original P by the conveying device 11.

At Step ST301 depicted in FIG. 15, the drive controller 19B2 turns on the front-side first light-source unit 32 and the rear-side first light-source unit 36, and turns off the front-side second light-source unit 33 and the rear-side second light-source unit 37. Next, at Step ST302, the information acquiring unit 19B1 acquires signals from the first image sensor 24 and the second image sensor 29. The signals correspond to direct-light line images LD3. More specifically, the information acquiring unit 19B1 acquires the direct-light line images LD3 at Step ST302. The storage device 19C stores the acquired signal associated with the position information of a portion read for each line in the sub-scanning direction.

Next, at Step ST303, the edge detector 19B4 determines whether any edge is included in the direct-light line image LD3 acquired at Step ST302. That is, the edge detector 19B4 performs edge detection. More specifically, the edge detector 19B4 determines whether any change like the signal S1 depicted in FIG. 6 is found in the acquired signal (direct-light line image LD3). When it is determined that no edge is included in the direct-light line image LD3 (No at Step ST303), the processor 19B returns to Step ST302. When it is determined that the edge is included in the direct-light line image LD3 (Yes at Step ST303), the processor 19B proceeds to Step ST304.

Next, at Step ST304, the drive controller 19B2 turns off the front-side first light-source unit 32 and the rear-side first light-source unit 36, and turns on the front-side second light-source unit 33 and the rear-side second light-source unit 37. Next, at Step ST305, the information acquiring unit 19B1 acquires signals from the first image sensor 24 and the second image sensor 29. The signals correspond to the reflected-light line images LD4. That is, the information acquiring unit 19B1 acquires the reflected-light line images LD4 at Step ST305. The storage device 19C stores the acquired information associated with the position information of a read portion in the sub-scanning direction.

Next, at Step ST306, the edge detector 19B4 determines whether any edge is included in the reflected-light line image LD4 acquired at Step ST305. That is, the edge detector 19B4 performs edge detection. Here, the edge detector 19B4 performs edge detection by reflected-light detection. More specifically, the edge detector 19B4 determines whether any change like the signal S3 depicted in FIG. 6 is found in the acquired signal. When it is determined that the edge is included in the reflected-light line image LD4 (Yes at Step ST306), the processor 19B returns to Step ST305. When it is determined that no edge is included in the reflected-light line image LD4 (No at Step ST306), then the processor 19B proceeds to Step ST307.

Next, at Step ST307, the image forming unit 19B3 forms an RGB read image D5 with reduced show-through depicted in FIG. 16. The RGB read image D5 includes the direct-light line images LD3 and the reflected-light line images LD4. In FIG. 16, E1 is the edge detected at Step ST303, and E2 is an edge last detected at Step ST306. More specifically, the edge E1 is an edge detected first after reading of the original P is started by the image reading apparatus, and the edge E2 is an edge detected last after the reading of the original P is started by the image reading apparatus. Here, the edge E1 is detected in line L2 and the edge E2 is detected in line Ln. The information acquiring unit 19B1 acquires the direct-light line images LD3 in line L1 and line L2 (Step ST302). The information acquiring unit 19B1 acquires the reflected-light line images LD4 in line L3 to line Ln+1 (Step ST305). The image forming unit 19B3 forms the RGB read image D5 in which these direct-light line images LD3 and reflected-light line images LD4 are arranged in the sub-scanning direction.

Next, at Step ST308, the edge detector 19B4 detects the edges of the cut-out image D0 included in the RGB read image D5 formed by the image forming unit 19B3 at Step ST306. The edge detector 19B4 according to the third embodiment performs edge detection based on the two methods such as the direct-light detection and the reflected-light detection. More specifically, the edge detector 19B4 detects the edge by the direct-light detection in line L2 depicted in FIG. 16, and detects the edge by the reflected-light detection in a range from line L3 to line Ln+1. The processor 19B executes Step ST308 and proceeds to Step ST309. Step ST309 and Step ST310 are the same as Step ST208 and Step ST209 depicted in FIG. 10. Therefore, explanation of Step ST309 and Step ST310 is omitted.

The processor 19B executes the control procedure, and this allows the image reading apparatus according to the third embodiment to implement edge detection by the direct-light detection based on the configuration in which a pair of imaging units is oppositely provided across the conveyance path R. More specifically, the edge detector 19B4 detects the edge E1 by the direct-light detection. As explained above, higher accuracy than that of edge detection by the reflected-light detection is expected in the edge detection by the direct-light detection. Thus, the image reading apparatus according to the third embodiment can improve the accuracy of detection of the edge E1. Furthermore, the image reading apparatus according to the third embodiment turns off the rear-side first light-source unit 36 depicted in FIG. 9 in a period from detecting the edge E1 to detecting the edge E2. More specifically, the information acquiring unit 19B1 does not acquire the direct-light line image LD3 in a range including the image of the printed front surface P1 but acquires the reflected-light line image LD4 in each line. With this feature, the image reading apparatus according to the third embodiment has the image data with no missing line in the range. Therefore, the processor 19B does not require the step of interpolating the missing line image. Thus, the image reading apparatus according to the third embodiment can more appropriately suppress degradation of image quality of the cut-out image D0. In addition, while ensuring the image quality equivalent to or higher than the image reading apparatus 30 according to the second embodiment, the image reading apparatus according to the third embodiment can read the original P at the same speed.

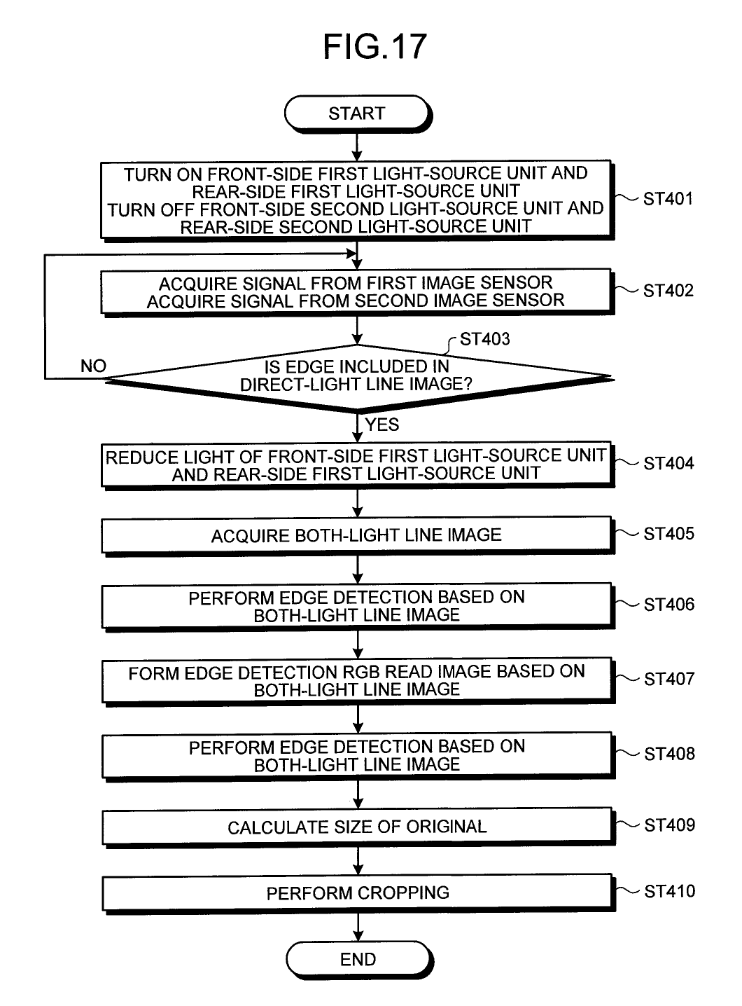

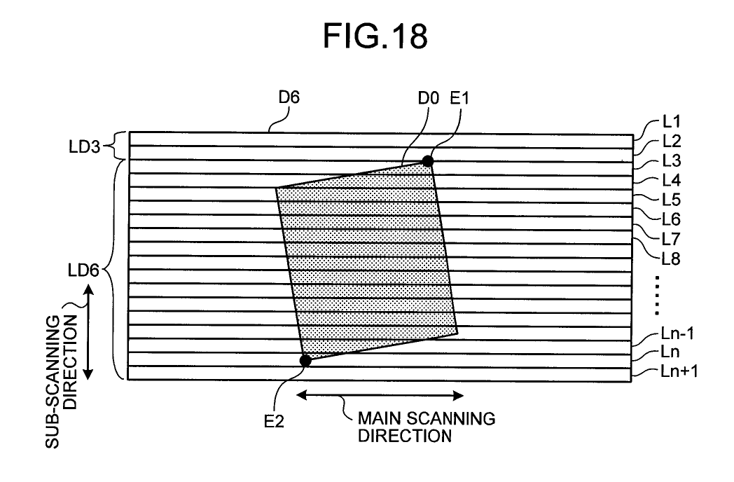

FIG. 17 is a flowchart of a control procedure according to a third embodiment. FIG. 18 is an explanatory diagram schematically representing RGB read image data according to the second modified example. An image reading apparatus according to the second modified example has the same configuration as that of the image reading apparatus 30 depicted in FIG. 9. In addition, a control procedure according to the second modified example is similar to the control procedure depicted in FIG. 15. Portions different from the control procedure depicted in FIG. 15 will be explained below. The control unit according to the second modified example executes Step ST401. Steps from Step ST401 to Step ST403 are the same as these from Step ST301 to Step ST303.

Next, at Step ST404, the drive controller 19B2 does not turn off the front-side first light-source unit 32 and the rear-side first light-source unit 36 but reduces each light quantity emitted from the front-side first light-source unit 32 and the rear-side first light-source unit 36. More specifically, the drive controller 19B2 controls each light quantity emitted from the front-side first light-source unit 32 and the rear-side first light-source unit 36 so that each light quantity emitted from the front-side first light-source unit 32 and the rear-side first light-source unit 36 is less than each light quantity emitted from the front-side second light-source unit 33 and the rear-side second light-source unit 37.

Next, at Step ST405, the information acquiring unit 19B1 acquires both-light line images LD6 depicted in FIG. 18. The both-light line images LD6 are used as an image for image formation and an image for edge detection. The both-light line images LD6 also include an image due to the light T332 emitted by the front-side second light-source unit 33 and reflected by the printed front surface P1, in addition to the image due to the light T36 emitted by the rear-side first light-source unit 36. Namely, the both-light line images LD6 acquired herein are line images with show-through. Next, at Step ST406, the edge detector 19B4 determines whether there is an edge based on the both-light line images LD6. That is, the edge detector 19B4 determines the presence or absence of an edge by the direct-light detection. Next, at Step ST407, an RGB read image D6 with reduced show-through depicted in FIG. 18 is formed. A method of forming the RGB read image D6 with reduced show-through will be explained below.

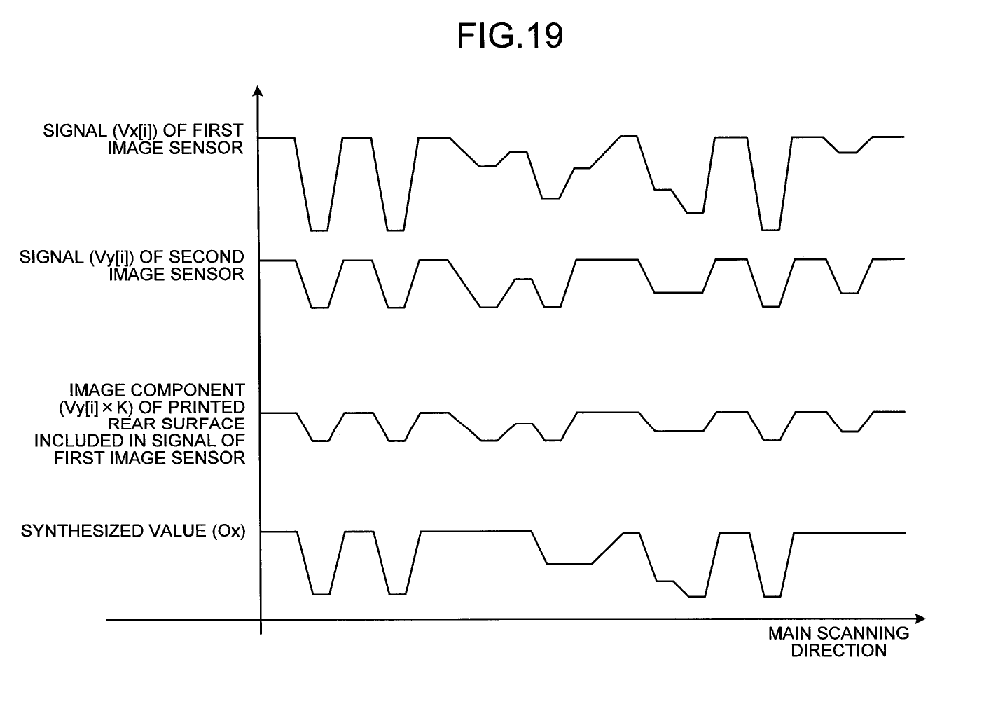

FIG. 19 is an explanatory diagram for explaining a method of forming the RGB read image with reduced show-through. The horizontal axis in FIG. 19 represents a position thereof in the main scanning direction, and the vertical axis represents each magnitude of signals output by the first image sensor 24 or by the second image sensor 29. Vx[i] is a signal output by an i-th sensor element of the first image sensor 24, Vy[i] is a signal output by an i-th sensor element of the second image sensor 29, Vy[i]xK is an image component of the printed rear surface P2 included in the signal output by the i-th sensor element of the first image sensor 24, and Ox represents a synthesized value. First, the information acquiring unit 19B1 acquires the signal Vx[i] output by the i-th sensor element of the first image sensor 24 and the signal Vy[i] output by the i-th sensor element of the second image sensor 29 from the storage device 19C. Next, the processor 19B multiplies the signal Vy[i] and a light transmittance K of the original P to calculate Vy[i]xK.

The light transmittance K may be a value calculated for each original P, or may be a predetermined value which is previously set. When the light transmittance K is to be calculated for each original P, the processor 19B calculates it in line L3 when the edge E1 depicted in FIG. 18 is to be detected. More specifically, the processor 19B calculates the light transmittance K based on a ratio of the signal output by the first image sensor 24 when the edge E1 is not detected (line L1) and the signal output by the first image sensor 24 when the edge E1 is detected (line L2).

Next, the processor 19B calculates the synthesized value Ox[i] based on the following Equation (4).

Ox[i]=Vx[i]−Vy[i]×K (4)

The synthesized value Ox[i] is element data with reduced show-through. The processor 19B performs the computation on the both-light line images LD6 in a period from detecting the edge E1 to detecting the edge E2 (from line L3 to line Ln). The processor 19B determines a set of synthesized values Ox[i], as a new line image, being a plurality of element data arranged in the main scanning direction. The edge detector 19B4 forms the RGB read image D6 with reduced show-through based on the new line image.

Next, at Step ST408 depicted in FIG. 17, the edge detector 19B4 determines whether there is an edge based on the both-light line images LD6. That is, the edge detector 19B4 performs edge detection by the direct-light detection. Next, the processor 19B executes Step ST409. Steps at Step ST409 and Step ST410 are the same as these at Step ST309 and Step ST310 respectively. Therefore, explanation of the steps at Step ST409 and Step ST410 is omitted. The control unit according to the second modified example executes Step ST410 and ends execution of the series of steps.

The processor 19B executes the control procedure, and this allows the image reading apparatus according to the second modified example to obtain the same effect as that of the image reading apparatus according to the third embodiment. Furthermore, the image reading apparatus according to the second modified example performs edge detection by the direct-light detection on all the lines including the image of the printed front surface P1. Higher accuracy than that of edge detection by the reflected-light detection is expected in the edge detection by the direct-light detection. Thus, the image reading apparatus according to the second modified example can more appropriately improve the accuracy of the edge detection.

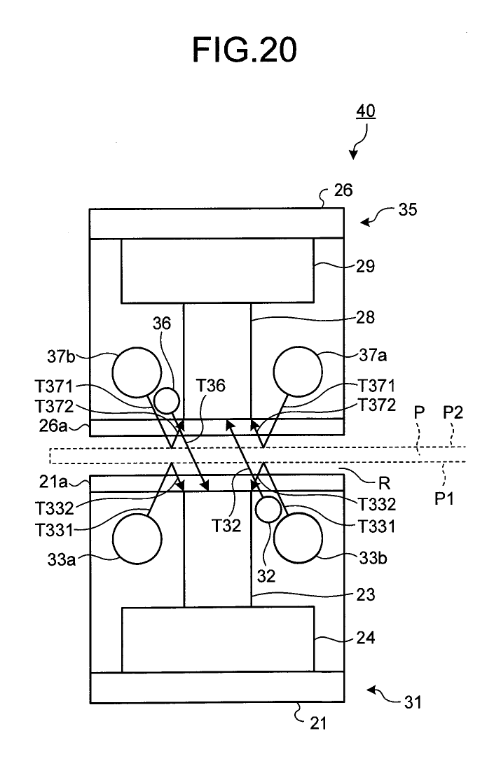

FIG. 20 is an explanatory diagram schematically representing an image reading apparatus according to a third modified example. An image reading apparatus 40 according to the third modified example has the number of light source units to be provided which is different from that of each image reading apparatus according to the second embodiment, the third embodiment, and the second modified example. More specifically, the image reading apparatus 40 includes six light source units: the front-side first light-source unit 32, a front-side second light-source unit 33a, a front-side second light-source unit 33b, the rear-side first light-source unit 36, a rear-side second light-source unit 37a, and a rear-side second light-source unit 37b. The front-side second light-source unit 33a and the front-side second light-source unit 33b correspond to the front-side second light-source unit 33 according to the second embodiment, the third embodiment, and the second modified example. The rear-side second light-source unit 37a and the rear-side second light-source unit 37b correspond to the rear-side second light-source unit 37 according to the second embodiment, the third embodiment, and the second modified example.

That is, the front-side second light-source unit 33a and the front-side second light-source unit 33b emit the lights T331 toward the conveyance path R. When the original P is present in the conveyance path R, the lights T331 are reflected by the printed front surface P1. The lights T332 reflected by the printed front surface P1 are guided to the first lens 23 of the first imaging unit 31. The front-side second light-source unit 33a and the front-side second light-source unit 33b are provided at positions where the lights are guided to the first image sensor 24 in the above manner.

The rear-side second light-source unit 37a and the rear-side second light-source unit 37b emit the lights T371 toward the conveyance path R. When the original P is present in the conveyance path R, the lights T371 are reflected by the printed rear surface P2. The lights T372 reflected by the printed rear surface P2 are guided to the second lens 28 of the second imaging unit 35. The rear-side second light-source unit 37a and the rear-side second light-source unit 37b are provided at positions where the lights are guided to the second image sensor 29 in the above manner.

The control procedure executed by the third modified example is the same as that of the second embodiment, the third embodiment, and the second modified example. However, at the step of turning on or off the front-side second light-source unit 33 of each control procedure according to the second embodiment, the third embodiment, and the second modified example, the control unit of the third modified example turns on or off the front-side second light-source unit 33a and the front-side second light-source unit 33b. In addition, at the step of turning on or off the rear-side second light-source unit 37 of each control procedure according to the second embodiment, the third embodiment, and the second modified example, the control unit of the third modified example turns on or off the rear-side second light-source unit 37a and the rear-side second light-source unit 37b.

If the control unit of the third modified example executes the same procedure as the control procedure of the second embodiment, the image reading apparatus 40 has the same effect as that of the image reading apparatus 30 according to the second embodiment. Moreover, if the control unit of the third modified example executes the same procedure as the control procedure of the third embodiment, the image reading apparatus 40 has the same effect as that of the image reading apparatus according to the third embodiment. Furthermore, if the control unit of the third modified example executes the same procedure as the control procedure of the second modified example, the image reading apparatus 40 has the same effect as that of the image reading apparatus according to the second modified example. In addition to these effects, the image reading apparatus 40 is provided with a larger number of light source units than that provided in each of the image reading apparatuses according to the second embodiment, the third embodiment, and the second modified example. Therefore, the image reading apparatus 40 can ensure a larger amount of light required to read the original P.

Here, in the image reading apparatuses, for example, the light source units simultaneously emit three colors of R light, G light, and B light as direct lights. However, each of the light source units may emit only one color as the direct light. In addition, each of the light source units may emit infrared rays. Even in these cases, each of the image reading apparatuses can perform edge detection using the direct light.

The image reading apparatus according to the present invention can detect an edge included in a read image using a direct light emitted from the light source oppositely provided to the image sensor. The edge detection using the direct light is not dependent on a light reflectivity of the read medium, and thus, higher accuracy thereof than that of the edge detection using the reflected light can be expected. Thus, the image reading apparatus according to the present invention has an effect that the accuracy of edge detection can be improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image reading apparatus, comprising a pair of imaging units, each including:
a light source configured to emit light; and
an image sensor configured to pick up an image of a medium to be moved relatively between the pair of imaging units, wherein
the light source of at least one of the imaging units is provided at a position where a direct light is guided to the image sensor of the other imaging unit, and
the image sensor of the other imaging unit is configured to pick up an image for image formation when a reflected light emitted from the light source of the other imaging unit and reflected by the medium is guided to the image sensor of the other imaging unit, and to pick up an image for edge detection when the direct light is guided to the image sensor of the other imaging unit, and
an edge of the medium is detected based on the image for edge detection.

2. The image reading apparatus according to claim 1, wherein the light source of the one of the imaging units and the light source of the other imaging unit are configured to be switched between a position where light is not guided to the image sensor of the other imaging unit and a position where light is guided to the image sensor of the other imaging unit.

3. The image reading apparatus according to claim 2, wherein the light source of the one of the imaging units is configured to not guide the direct light to the image sensor of the other imaging unit when the image sensor of the other imaging unit is picking up the image for image formation.

4. The image reading apparatus according to claim 1, wherein
the image sensor of the other imaging unit is configured to pick up a line image along a main scanning direction a plurality of times in a sub-scanning direction, and to repeat a process of picking up a reflected-light line image that is the image for image formation once or more and thereafter picking up a direct-light line image that is the image for edge detection, and
an image of the medium is formed based on the reflected-light line images picked up by the repetition.

5. The image reading apparatus according to claim 4, wherein a reflected-light line image that is missing due to the picking up of the direct-light line image is interpolated, based on at least two of the reflected-light line images picked up before and after a period in which the image sensor of the other imaging unit picks up the direct-light line image.

6. The image reading apparatus according claim 1, wherein
the direct light is guided to the image sensor of the other imaging unit until the edge is detected first after reading of the medium is started, and
when the edge is detected, the reflected light is guided to the image sensor of the other imaging unit.

7. The image reading apparatus according to claim 2, wherein
the direct light is guided to the image sensor of the other imaging unit until the edge is detected first after reading of the medium is started, and
when the edge is detected, the reflected light is guided to the image sensor of the other imaging unit, and the direct light having a light quantity less than that before the detection of the edge is guided to the image sensor of the other imaging unit.

8. The image reading apparatus according to claim 1, wherein
the image sensor of the other imaging unit is configured to pick up an image of a first surface of the medium,
the image sensor of the one of the imaging unit is configured to pick up an image of a second surface of the medium, and
a component of the image of the second surface is removed from the image of the first surface, based on the image of the second surface.

9. The image reading apparatus according to claim 1, wherein
at least one of the pair of imaging units is configured to move between a first position where the direct light is guided to the image sensor of the other imaging unit and a second position where the direct light is not guided to the image sensor of the other imaging unit.

10. The image reading apparatus according to claim 1, wherein the edge is detected based on the image for image formation.
